(19) United States
(12) Patent Application Publication
(10) Pub. No.: US 2015/0034006 A1
(43) Pub. Date: Feb. 5, 2015

(54) MASKING STRIP

(71) Applicants: Kin-Chau Chan, Tamworth (GB); Anna B. Baker, Nottingham (GB)

(72) Inventors: Kin-Chau Chan, Tamworth (GB); Anna B. Baker, Nottingham (GB)

(73) Assignee: 3M INNOVATIVE PROPERTIES COMPANY, ST. PAUL, MN (US)

(21) Appl. No.: 13/995,643

(22) PCT Filed: Dec. 21, 2011
(86) PCT No.: PCT/US11/66364

§ 371 Date: Jan. 16, 2014

(30) Foreign Application Priority Data
Dec. 24, 2010 (GB) 1021983.0

(51) Int. Cl. B05B 15/04

(52) U.S. Cl. CPC B05B 15/0462; B05B 15/0456
USPC 118/505

(57) ABSTRACT

A masking strip for masking the interior surfaces of a gap (8) between two substrates (2,3) to be painted is disclosed. The masking strip comprises a backing (10) having a first surface and a second surface. A gap filler (13) is also provided, extending from the backing (10) and adapted to prevent the flow of paint into the gap (8). The backing (10) is formed from, or attached to, a fibre—containing material that acts to wick paint away from the interior surface of the gap (8) to which the masking strip is fixed. Preferably the fibre—containing material is one of paper, tissue, a non-woven or a woven material.

The present invention relates to a masking strip, in particular a masking strip for masking the interior surfaces of a gap between two substrates to be painted.

In the automotive repair market it is common to use some type of masking material to achieve an accurate and smooth paint edge when spraying a vehicle part with paint, such as a coloured paint or clear lacquer. Existing products include masking tapes (such as Scotch High Performance Masking Tape 3434, available from 3M United Kingdom plc) and masking foam tapes (such as Soft Edge Masking Foam Tape, again available from 3M United Kingdom plc). One particular use is to mask the interior surfaces of a gap between two vehicle parts, one of which is static and one of which is moveable, such as an “A”, “B” or “C” pillar (the pillar of a vehicle between the windscreen and a front door, between a front door and a rear door, and between a rear door and a backlight, respectively), a front wing and a bonnet and a vehicle door. The aperture created in the vehicle bodywork may be termed the door opening aperture, and is bounded by at least one of the static vehicle parts mentioned above, the roof and the door sill. To achieve a smooth paint line in this situation the masking tape or foam is positioned within the gap between the two parts, and fixed to one of the interior surfaces of the gap between the parts using an adhesive. An edge of the tape or foam is positioned at the top of the gap nearest the surface to be sprayed. This can require considerable skill to achieve a smooth paint line. To improve the repeatability of the paint line several options are available. Firstly, it is possible to fold over one edge of a masking tape onto the adhesive side to create a spacer that acts to lift the edge of the tape away from the interior surface of the gap at the top. Allowing a non-contact region at the top of the gap allows a smooth paint line to be created as there is no pooling of the paint or lacquer against the hard edge of the masking tape. This creates a smooth paint line on the static vehicle part to which the masking tape is affixed with adhesive. Secondly, it is possible to use a masking tape or foam that is provided with a gap filler. An example of this is discussed in WO2008/023081, which is concerned with a sealing strip comprising a lateral adhesive sheet, or backing, which is provided with a joint, or gap, filler formed from an elastomer. The joint filler is positioned within the gap between the two vehicle parts to fill the gap and to be in contact with the interior surface of the gap formed by the moveable vehicle part. In addition, to provide a smooth paint line the lateral adhesive sheet is positioned proud of the top of the gap to prevent overspray.

Even if a spacer or gap filler is provided it may still be necessary to apply the masking strip with skill if masking a complex shape or small gap, both of which are found increasingly in modern vehicles. With this in mind, the foam materials used in masking foam tapes and masking strips may be open cell materials, allowing paint or lacquer that is oversprayed to be absorbed away from the edge of the masking tape or strip. An example of this is discussed in WO2006/109093, which is concerned with a masking strip having at least one non-adhesive foam region that when paint pools against it absorbs the paint and produces a smooth paint line. A second approach is to provide a masking tape material with an absorbent edge coating, such as discussed in WO2003/092996. The absorbent edge material is intended to absorb paint to prevent it from being absorbed by the main body of a masking tape and passing between the tape and the surface it is fixed to, which may otherwise cause a rough paint line. A superabsorbent material is proposed as being particularly suitable to form the absorbent edge material.

However, whilst each of these solutions, when used carefully and correctly, gives a smooth paint line on the movable and/or static vehicle parts, it would be advantageous to be able to produce such a smooth paint line on the static vehicle part repeatedly without the need to employ absorbent foam materials, edge coatings or spacers.

The present invention aims to offer this alternative by providing a masking strip for masking the interior surfaces of a gap between two substrates to be painted, comprising: a backing having a first surface and a second surface, and a gap filler, extending from the backing and adapted to prevent the flow of paint into the gap; wherein the backing is formed from, or attached to, a fibre-containing material that acts to wick paint away from the interior surface of the gap to which the masking strip is fixed.

The advantage of providing a material that wicks paint away from the interior surface of the gap is that any excess paint will not have chance to pool against the edge of the masking strip, which may create a hard edge or otherwise spoil the finish of a smooth paint line.

Preferably the gap filler extends from the first surface or the second surface of the backing

The second surface of the backing may carry an adhesive to fix the masking strip to an interior surface of the gap.

The masking strip may further comprise a spacer attached to the second surface of the backing In this case preferably the spacer is formed from the fibre-containing material The spacer may be a composite spacer comprising a base layer and a cover layer. Preferably the cover layer is a fibre-containing material.

Preferably the fibre-containing material contains at least one of natural, cellulose or synthetic fibres. The fibre-containing material may comprise one of: paper, tissue, woven material or non-woven material. A paper material preferably has a weight in the range 35 to 100 gsm. A paper material may be textured. A tissue material may have a weight in the range 10 to 35 gsm.

The fibre-containing material may be perforated.

Preferably the gap filler comprises a foam material.

The present invention will now be described by way of example only and with reference to the accompanying drawings, in which:

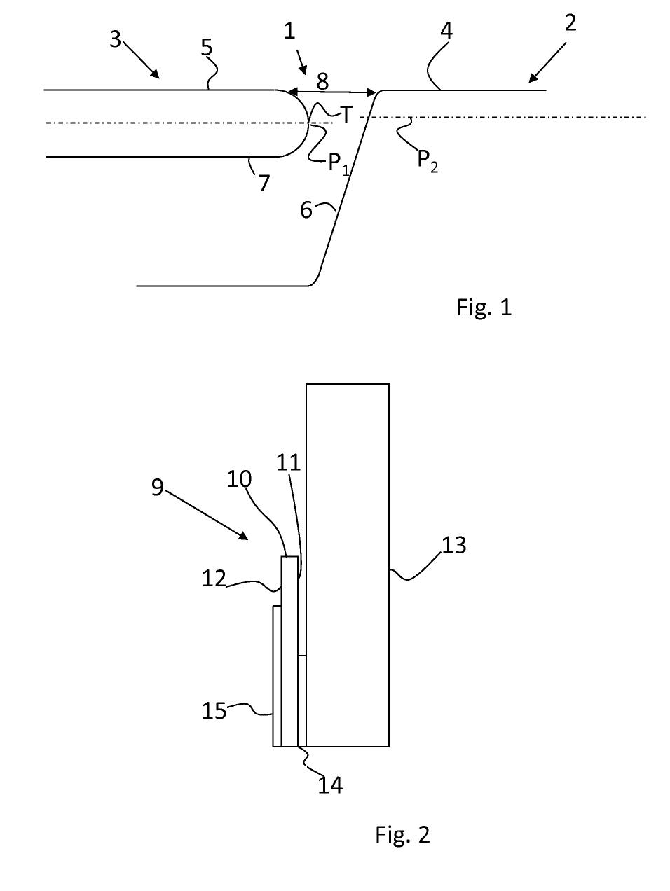

FIG. 1 is a schematic drawing illustrating the interior surfaces of a gap between two substrates, both formed from vehicle parts, to be painted;

FIG. 2 is a schematic cross-section of a masking strip in accordance with a first embodiment of the present invention;

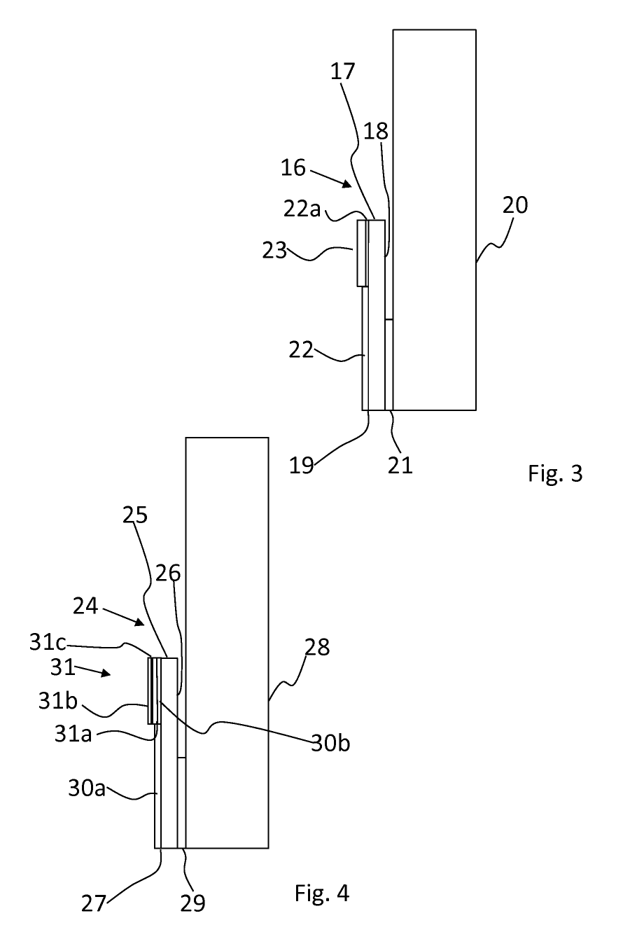

FIG. 3 is a schematic cross-section of a masking strip in accordance with a second embodiment of the present invention;

FIG. 4 is a schematic cross-section of a masking strip in accordance with a third embodiment of the present invention;

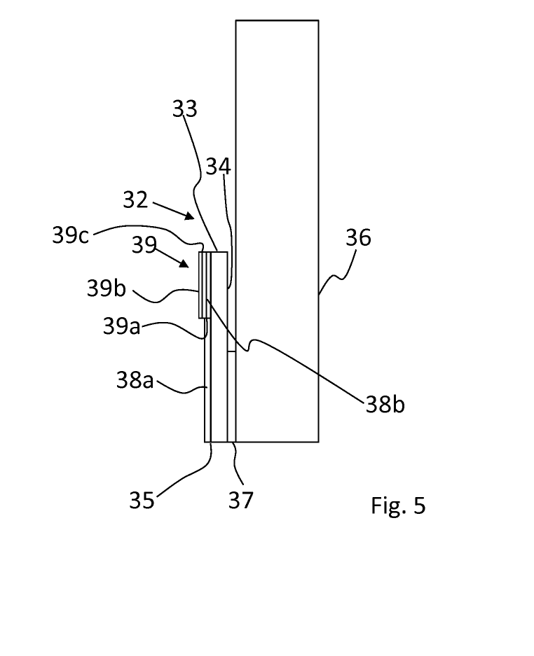

FIG. 5 is a schematic cross-section of a masking strip in accordance with a fourth embodiment of the present invention;

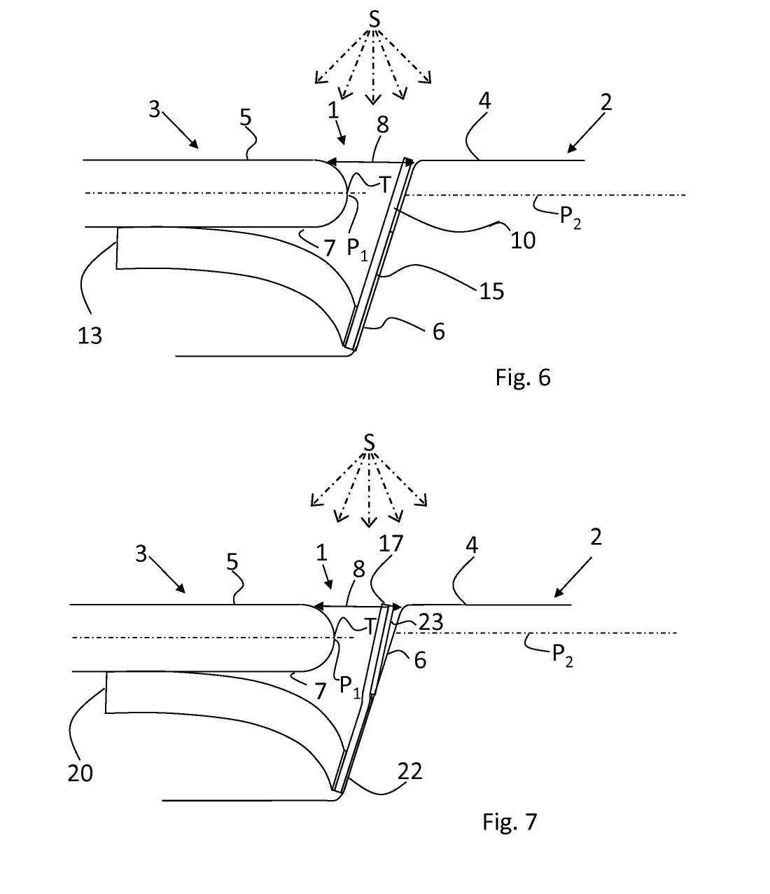

FIG. 6 is a schematic cross-section showing a masking strip in accordance with the first embodiment of the present invention in position within a gap; and

FIG. 7 is a schematic cross-section showing a masking strip in accordance with the second embodiment of the present invention in position within a gap.

In the present invention a different approach has been adopted. Rather than use an absorbent foam material or a spacer alone to create a smooth paint line on a static vehicle part, a fibre-containing material is employed to wick paint away from the interior surface of the gap to which the masking strip is fixed. By wicking paint away from the interior surface pooling of paint along the edge of the masking strip is avoided, which in turn leads to a smooth paint edge. To ensure that a smooth paint edge is also achieved on the interior surface of the gap to which the masking strip is not fixed, a gap filler is employed. In the following description references to “paint” should be understood to include a base coat (the coloured paint layer seen on vehicles) and a clear coat (also known as lacquer), and a smooth paint edge is an edge that is smooth to touch, which does not cause a finger nail to catch against the edge of the paint coating.

FIG. 1 is a schematic drawing illustrating the interior surfaces of a gap between two substrates, both formed from vehicle parts, to be painted. The gap 1 is formed between a static vehicle part 2 and a moveable vehicle part 3. In the example shown the static vehicle part 2 is a “B” pillar and the moveable vehicle part 3 is a door. The static vehicle part 2 presents a first substrate 4 to be painted and the moveable vehicle part 3 presents a second substrate 5 to be painted. The gap 1 comprises two interior surfaces. The first interior surface 6 is formed from the interior surface of the static vehicle part 2, and the second interior surface 7 is formed from the interior surface of the moveable vehicle part 3. The interior surface of the moveable vehicle part 3 is comprises a curved surface having a turning point T, which is effectively determined by the thickness of the material forming the outer shell of the moveable vehicle part 3. The top 8 of the gap 1 is defined as coinciding with the first 4 and second 5 substrates to be painted. A paint line P₁ will be formed at the boundary between a painted region of the second substrate 5 of the moveable vehicle part 3 and a non-painted region. The non-painted region generally corresponds with the underside of the moveable vehicle part 3, and the paint line typically lies adjacent to or at the turning point T. A second paint line P₂ is formed on the static vehicle part 2, and its position is determined by the position of the masking strip within the gap 1 will be discussed in more detail below. The exact position of the second paint line P2 will vary depending on the vehicle model (shape of the gap 1 and static vehicle part 2) and the position of the masking strip. However, this second paint line P₂ must also be as smooth as possible.

FIG. 2 is a schematic cross-section of a masking strip in accordance with a first embodiment of the present invention. The masking strip 9 comprises a backing 10 having a first surface 11 and a second surface 12 and a gap filler 13 extending from the first surface 11 of the backing 10. The gap filler 13 is bonded to the backing by an adhesive 14. The gap filler 13 extends from backing 10, allowing it to have no or minimal contact with a portion of the second interior surface 7 of the gap 1 just at or in the region of the turning point T of the moveable vehicle part 3, thus creating a smooth paint line P₁ on the moveable vehicle part 3. This is achieved by ensuring that the gap filler 13 is adapted to prevent the flow of paint into the gap 1. The backing 10 is formed from two layers of SG 54 crepe paper available from Neenah Gessner GmbH, Otto-von-Steinbeisstr. 14b, 83052 Bruckmühl, Germany, having an elongation of 14%, which is a fibre-containing material that acts to wick the paint away from the interior surface 6 of the gap 1 to which the masking strip 9 is fixed. The second surface 12 of the backing 10 carries an adhesive 15 to fix the masking strip to the first interior surface 6 of the gap 1.

FIG. 3 is schematic cross-section of a masking strip in accordance with a second embodiment of the present invention. The masking strip 16 comprises a backing 17 having a first surface 18 and a second surface 19 and a gap filler 20 extending from the first surface 18 of the backing 17. The gap filler 20 is bonded to the backing 17 by means of an adhesive layer 21. The gap filler 20 extends from the backing 17, allowing it to have no or minimal contact with a portion of the second interior surface 7 of the gap 1 just at or in the region of the turning point T of the moveable vehicle part 3 such that the paint line P₁ is formed, thus creating a smooth paint line on the moveable vehicle part 3. This is achieved by ensuring that the gap filler 20 is adapted to prevent the flow of paint into the gap 1. The backing 18 is provided with an adhesive layer 22, which is used to fix the masking strip 16 to the first interior surface 6 of the gap 1. A spacer 23 is attached to the second surface 19 of the backing 17, by means of an adhesive layer 22a, formed from 3M 300 LSE Laminating Adhesive. The spacer 23 is made from 80 gsm plain office paper, which is a fibre-containing material that acts to wick the paint away from the interior surface 6 of the gap 1 to which the masking strip 16 is fixed. Thus the backing 17 carries the fibre-containing material as the spacer 23 is fixed to the backing 17 by the adhesive 22a.

FIG. 4 is schematic cross-section of a masking strip in accordance with a third embodiment of the present invention. The masking strip 24 comprises a backing 25 having a first surface 26 and a second surface 27 and a gap filler 28 extending from the first surface 26 of the backing 25. The gap filler 28 is bonded to the backing 25 by means of an adhesive layer 29. The gap filler 28 extends from the backing 25, allowing it to have no or minimal contact with a portion of the second interior surface 7 of the gap 1 just at or in the region of the turning point T of the moveable vehicle part 3, thus creating a smooth paint line P₁ on the moveable vehicle part 3. This is achieved by ensuring that the gap filler 13 is adapted to prevent the flow of paint into the gap 1. The backing 25 is provided with an adhesive layer 30a, which is used to fix the masking strip 24 to the first interior surface 6 of the gap 1. A composite spacer 31, comprising a foam material base 31a and a cover layer 3 lb formed from a fibre-containing material and joined together by an adhesive layer 31c is attached to the second surface 27 of the backing 25, by means of a further adhesive layer 30b. The cover layer 3 lb is made from a non-woven material: a spunbond blown melt fibre non-woven material with a smooth finish, formed from polypropylene fibres. The weight of the material was approximately 20 gsm. This is a fibre-containing material that acts to wick the paint away from the interior surface 6 of the gap 1 to which the masking strip 24 is fixed. Thus the backing 25 carries the fibre-containing material as the composite spacer 31 is fixed to the backing 25 by the adhesive layer 30b.

FIG. 5 is schematic cross-section of a masking strip in accordance with a third embodiment of the present invention. The masking strip 32 comprises a backing 33 having a first surface 34 and a second surface 35 and a gap filler 36 extending from the first surface 34 of the backing 33. The gap filler 36 is adapted to prevent the flow of paint into the gap 1. The gap filler 36 extends from the backing 33, allowing it to have no or minimal contact with a portion of the second interior surface 7 of the gap 1 just at or in the region of the turning point T of the moveable vehicle part 3, such that the paint line P₁ is formed, thus creating a smooth paint line on the moveable vehicle part 3. This is achieved by ensuring that the gap filler 13 is adapted to prevent the flow of paint into the gap 1. The backing 33 is provided with an adhesive layer 38a, which is used to fix the masking strip 32 to the first interior surface 6 of the gap 1. A composite spacer 39, comprising a foam material base 39a and a cover layer 39b formed from a fibre-containing material is attached to the second surface 35 of the backing 33, by means of a second adhesive layer 38b. The base 39a and cover layer 39b are joined by a layer of adhesive 39c. The cover layer 39b is made from a tissue material having a weight of 15 gsm, which is a fibre-containing material that acts to wick the paint away from the interior surface 6 of the gap 1 to which the masking strip 32 is fixed. Two versions of this embodiment were made: the first with a commercially available facial tissue product; and the second with a commercially available absorbent tissue napkin product. Thus the backing 33 carries the fibre-containing material as the composite spacer 39 is fixed to the backing 33 by the adhesive layer 38b.

FIG. 6 is cross-section showing a masking strip in accordance with the first embodiment of the present invention in position within a gap. The adhesive layer 15 is placed in contact with the first interior surface 6 of the gap 1, such that the uppermost edge of the backing 10 is positioned at the top 8 of the gap 1, and therefore flush with the first substrate 4. The gap filler 13 is positioned below the turning point T such that it has no or minimal contact with a portion of the second interior surface 7 of the gap 1 just at or in the region of the turning point T of the moveable vehicle part 3, such that the paint line P₁ is formed. The direction of paint spray, indicated by the arrows S shows that paint will pool at the uppermost edge of the backing 10, but will be wicked away by the crepe paper due to capillary action of the liquid along the fibres within the crepe paper. This allows paint line P₂ to be formed in the region of the top of the backing 10.

FIG. 7 is cross-section showing a masking strip in accordance with the second, third and fourth embodiments of the present invention in position within a gap. The adhesive layer 22, 30a, 38a is placed in contact with the first interior surface 6 of the gap 1, such that the uppermost edge of the backing 17, 25, 33 is positioned at the top 8 of the gap 1. The spacer 23, 31, 39 is also positioned at the top 8 of the gap 1. The gap filler 20, 28, 36 is positioned below the turning point T such that it has no or minimal contact with a portion of the second interior surface 7 of the gap 1 just at or in the region of the turning point T of the moveable vehicle part 3, such that the paint line P₁ is formed. The direction of paint spray, indicated by the arrows S shows that paint will pool at the uppermost edge of the backing 17, 25, 33, but will be wicked away by the plain office paper, non-woven or tissue due to capillary action of the liquid along the fibres within the material used. This allows paint line P₂ to be formed in the region of the top of the spacer 23, 31, 39.

All the embodiments of the present invention described above were made on a laboratory scale and tested in a front door opening aperture of a 2007 Vauxhall Astra 3-door hatchback. In use, the door was opened and the masking strips applied to the interior surface of the static vehicle part, which in this example included the “B” pillar, roof and door sill. The spacer was positioned at the top of the gap adjacent the static vehicle panel and the door closed, causing the gap filler to fill the gap. A clear coat (P190-6990 with hardener P210-872 and diluent P850-1694, all available from PPG Industries (UK) Limited, Needham Road Stowmarket Suffolk IP14 2AD) was sprayed onto the vehicle. All four embodiments of the present invention resulted in a smooth paint line on the static vehicle part tested.

In two of the embodiments described above the fibre-containing material used is a paper material. In the case of crepe paper, the paper material is textured. Suitable paper materials include plain or coloured office paper, crepe paper, tissue paper and lightweight cardstock. Alternatively, the paper material can be chosen by weight, and preferably has a weight in the range of 35 to 100 gsm. Lighterweight tissue materials are employed in the fourth embodiment described above. Such materials can be chosen to have a weight preferably in the range 10 to 35 gsm. As an alternative to the non-woven material used in the third embodiment described above, woven materials, such as textiles, may be used as the fibre-containing materials. In each case, suitable materials are those that do no exhibit excessive linting or other disintegration or delamination behaviour in use or manufacture of the masking strip.

Preferably the fibre-containing material contains at least one of natural, cellulose or synthetic fibres. Suitable natural fibres include vegetable and animal derived fibres such as: silk, cotton, jute, flax, ramie, sisal, and hemp; suitable cellulose fibres include regenerated and pure cellulose, such as rayon; suitable synthetic fibres include extruded fibres such as: nylon, polyester, acrylic, polypropylene and polyolefin. To improve the wicking behaviour of the fibre-containing material it may be perforated. The spacer 23, 31, 39 has a thickness preferably in the range 0.6 mm and 1.1 mm. The height of the spacer 23, 31, 39 is preferably in the 3 mm and 8 mm.

The gap filler 13, 20, 28, 36 is preferably formed from a foam material, such as an open or closed cell foam material, but is preferably a closed-cell foam material such as a polyurethane foam, for example, Caligen X4200AM (RTM), available in the UK from CALIGEN FOAM LTD, Broad Oak, Accrington, Lancashire, BB5 2BS. The gap filler 13, 20, 28, 36 may be crimped at the point it extends from the backing 10, 17, 25, 33. If the backing 17, 25, 33 is not formed from the fibre-containing material it is also preferably formed from a foam material, such as an open or a closed cell material. The gap filler 13, 20, 28, 36 extends from the backing 10, 17, 25, 33 so as to be parallel in FIGS. 2, 3, 4 and 5. However, as an alternative, the gap filler 13, 20, 28, 36 may extend from the backing 10, 17, 25, 33 at an angle a, which is preferably less than or equal to 90° . The thickness of the gap filler 13, 20, 28, 36 is preferably within the range 3 mm to 8 mm. The length of the gap filler 13, 20, 28, 36 (the distance between where it is proximal and distal the backing 10, 17, 25, 33) is preferably in the range 5 mm and 22 mm. It may also be desirable for the backing 10, 17, 25, 33 to have a bevelled edge, such that in use, its upper end slopes away from the turning point T. As an alternative, the backing 10, 17, 25, 33 may be bent or kinked to achieve the same effect.

In the embodiments of the present invention where the backing is a foam material, it is preferably a strip of flexible, compressible and/or conformable material, such as a polyethylene foam material, for example, Aveolite TA1001®, available in the UK from SEKISUI ALVEO AG, Queens Chambers, Eleanors Cross, Dunstable, Bedfordshire, LU6 1SU. Where the gap filler 13, 20, 28, 36 and the backing 10, 17, 25, 33 are both foam materials, one may be chosen to be more dense than the other, for example, the foam material forming the backing 10, 17, 25, 33 may be more dense than the foam material forming the gap filler 13, 20, 28, 36.

In the above embodiments of the present invention a two-part construction of the masking strip (utilising a separate gap filler 13, 20, 28, 36 and backing 10, 17, 25, 33) is used. In this case the gap filler may extends from either the first or the second surface of the backing, with the former being shown in the embodiments. However, the backing 10, 17, 25, 33 and the gap filler 13, 20, 28, 36 may be formed as an integral body from a single strip of material, such as a foam material or a fibre-containing material (in the case of the first embodiment of the present invention).

The embodiments of the present invention described above are suitable for use in masking a gap formed between any static and moveable vehicle panel forming part of a door opening aperture. A door may be framed or frameless, and the gap filler 13, 20, 28, 36 may be sized to fill a large gap or a small gap, or may be folded in on itself or shaped to create a compressible body that is easily positioned and held within either a large gap or a small gap.

Although the backing 17, 25, 33 and gap filler 13, 20, 28, 36 when formed of a foam material are preferably elongate bodies of rectangular cross-section, the cross-section of each may be triangular, elliptical or polygonal. In each of the embodiments described above, the gap filler 13, 20, 28, 36 extends from the first surface 11, 18, 26, 34 of the backing 10, 17, 25, 33. However, as an alternative the gap filler 13, 20, 28, 36 may extend from the second surface 12, 19, 27, 35 of the backing 10, 17, 25, 33. In this case it may also be folded or otherwise bent away from the adhesive layer 15, 22, 30a, 38b. Any suitable adhesive may be used to join the backing 10, 17, 25, 33, the gap filler 13, 20, 28, 36, the spacer 23, 31, 39, and the parts of the composite spacer 31, 31a, 31b, 39, 39a, 39b together.

1. Masking strip for masking the interior surfaces of a gap between a first substrate and a second substrate to be painted, comprising:
a backing having a first surface and a second surface, and
a gap filler extending from the backing and adapted to prevent the flow of paint into the gap;
wherein the backing is formed from, or attached to, a fibre-containing material that acts to wick paint away from the interior surface of the gap to which the masking strip is fixed.

2. Masking strip as claimed in claim 1, wherein the gap filler extends from the first surface or the second surface of the backing

3. Masking strip as claimed in claim 1, wherein the second surface of the backing carries an adhesive to fix the masking strip to an interior surface of the gap.

4. Masking strip as claimed in claim 1, wherein the strip further comprises a spacer attached to the second surface of the backing

5. Masking strip as claimed in claim 4, wherein the spacer is formed from the fibre-containing material

6. Masking strip as claimed in claim 4, wherein the spacer is a composite spacer comprising a base layer and a cover layer.

7. Masking strip as claimed in claim 6, wherein the cover layer is a fibre-containing material.

8. Masking strip as claimed in claim 1, wherein the fibre-containing material contains at least one of natural, cellulose or synthetic fibres.

9. Masking strip as claimed in claim 1, wherein the fibre-containing material comprises one of: paper, tissue, woven material or non-woven material.

10. Masking strip as claimed in claim 9, wherein the paper material has a weight in the range 35 to 100 gsm.

11. Masking strip as claimed in claim 9, wherein the paper material is textured.

12. Masking strip as claimed in claim 9, wherein the tissue material has a weight in the range 10 to 35 gsm.

13. Masking strip as claimed in claim 1, wherein the fibre-containing material is perforated.

14. Masking strip as claimed in claim 1, wherein the gap filler comprises a foam material.
